(19) United States
(12) Patent Application Publication
(10) Pub. No.: US 2026/0153129 A1
(43) Pub. Date: Jun. 4, 2026

(54) BEARING SYSTEM INCLUDING A GROUNDING BRUSH ASSEMBLY

(71) Applicant: AKTIEBOLAGET SKF, GOTEBORG (SE)

(72) Inventors: Benoit ARNAULT, Saint-Cyr-sur-Loire (FR); Mickael CHOLLET, Joué-Lès-Tours (FR)

(21) Appl. No.: 19/395,301

(22) Filed: Nov. 20, 2025

(30) Foreign Application Priority Data
Dec. 4, 2024 (FR) FR2413402

(51) Int. Cl. F16C 41/00; F16C 19/06

(52) U.S. Cl. CPC F16C 41/002; F16C 19/06

(57) ABSTRACT

A bearing system includes a bearing and a grounding brush assembly fixed to the outer ring of the bearing. The grounding brush assembly includes a brush offset axially outwardly with respect to the inner ring of the bearing and provided with a plurality of conductive fibers and a support for the conductive fibers. The conductive fibers include a first group of fibers, the free ends of which define the inside diameter of the brush, and a second group of fibers, the radial length of each one of the second group of fibers being reduced and the free ends of which are offset radially outwardly with respect to the bore of the inner ring of the bearing.

### CROSS-REFERENCE

This application claims priority to French patent application no. 2413402 filed on December 4, 2024, the contents of which are fully incorporated herein by reference.

### BACKGROUND OF THE INVENTION

The present invention relates to grounding devices for controlling the shaft current generated in electric motors or machines, and more particularly to grounding brush assemblies.

In an electric motor or machine, at least one rolling bearing is typically mounted between a casing of the electric motor or machine and a rotary shaft in order to support rotatably support and couple the shaft with the casing.

During operation of the electric motor or machine when the shaft is rotating, a difference in electric potential may arise between the shaft and the casing of the electric motor or machine, which may generate an electric current between the inner ring of the rolling bearing, which is connected to the shaft, and the outer ring which is connected to the casing.

Such an electric current flowing through the components of the rolling bearing may damage these components, particularly the rolling elements and raceways provided on the inner and outer rings. These electric discharges may also cause vibrations.

In order to remedy these drawbacks, it is known practice to earth or ground the rotary shaft by using a grounding brush comprising conductive fibers. The grounding brush is generally mounted in the bore of the casing of the electric motor in such a way that the free ends of the fibers are in radial contact with the outer surface of the rotary shaft.

Due to the conductivity of the fibers, the brush is kept at the same electric potential as the casing of the electric motor. The inner and outer rings of the rolling bearing are also at the same electric potential, which reduces or even eliminates problematic electric discharges through the rolling bearing.

US Patent Publication No. 2021/0021180 A1 discloses a grounding brush assembly comprising a grounding brush provided with a plurality of conductive fibers, a support in which the conductive fibers are mounted, and an annular mounting plate comprising a plurality of retaining tongues for radially and axially retaining the support, and an annular outer flange radially surrounding the brush and the tongues.

It is also possible to equip the rolling bearing with the grounding brush assembly.

However, with such a solution, mounting of this assembly between the casing and the rotary shaft of the electric motor can be difficult to accomplish.

### SUMMARY OF THE INVENTION

The present invention aims to remedy the drawback discussed above and relates to a bearing system comprising a bearing provided with a first ring and a second ring able to rotate relative to each other.

The system also comprises a grounding brush assembly fixed to the outer ring of the bearing and comprising a brush axially offset outwardly with respect to the inner ring of the bearing and provided with a plurality of conductive fibers and with a support in which the conductive fibers are mounted. The conductive fibers protrude radially inwards with respect to the support.

According to a general characteristic, the conductive fibers of the brush of the grounding brush assembly comprise a first group of fibers, the free ends of which define the inside diameter of the brush.

According to a general characteristic, the conductive fibers of the brush comprise a second group of fibers, the protruding radial length of which is reduced relative to the protruding radial length of the first group of fibers and the free ends of which are offset radially outwards with respect to the bore of the inner ring of the bearing.

With such a design of the brush of the grounding brush assembly, the bearing system can easily be mounted inside the casing of the associated electric motor simply by being pushed axially onto the inner ring of the bearing while passing axially through the zone or zones of reduced radial dimension of the conductive fibers of the brush which are delimited radially by the second group of fibers.

The free ends of the second group of fibers of the conductive fibers may be located in the zone located radially between the immediate vicinity of the bore of the inner ring of the bearing, for example at the top of an inlet chamfer of the bore, and between the outer surface of the inner ring.

The free ends of the first group of fibers of the conductive fibers may be offset radially inwardly with respect to the bore of the inner ring of the bearing, or alternatively are flush with the bore. In another alternative, the free ends of the conductive fibers may be radially set back or offset with respect to the bore in the particular design in which the bearing system further comprises a sleeve mounted in the bore of the inner ring.

In one embodiment, the bore of the brush of the grounding brush assembly has a crenellated shape, each opening of the crenellated shape being delimited radially by conductive fibers of the second group of fibers and circumferentially by conductive fibers of the first group of fibers.

In one embodiment, the grounding brush assembly is fixed directly to the outer ring of the bearing without the interposition of an intermediate element. Alternatively, it is still possible to provide for the grounding brush assembly to be fixed with an intermediate element, but this increases the overall cost of the system.

Preferably, the grounding brush assembly is fixed within a groove formed in the bore of the outer ring of the bearing. Alternatively, it is possible to fix the grounding brush assembly to another zone of the outer ring of the bearing, for example to an end face or to its outer surface, with or without the interposition of an intermediate element.

The grounding brush assembly may further comprise a brush mounting plate that is integral with the brush support and is fixed to the outer ring of the bearing.

In a particular embodiment, the bearing of the system comprises at least one row of rolling elements disposed between raceways of the first and second rings. Alternatively, the bearing could be of the plain bearing type.

The present invention also relates to a kit comprising a bearing system as defined hereinabove and a mounting tool comprising at least one finger having a radial dimension smaller or less than the radial distance between the bore of the inner ring of the bearing and the free ends of the second group of fibers of the conductive fibers of the brush of the grounding brush assembly.

The present invention further relates to an electric motor comprising a casing, a shaft and at least one bearing system as defined hereinabove mounted radially between the casing and the shaft, the first group of fibers of the conductive fibers of the brush of the grounding brush assembly being in contact with the shaft.

The present invention also relates to a method for mounting a bearing system as defined hereinabove between a casing and a shaft of an electric motor, wherein the bearing system is pushed along the shaft by means of a mounting tool disposed radially between the shaft and the free ends of the second group of fibers of the conductive fibers of the brush of the grounding brush assembly, and axially bearing against the inner ring of the bearing.

### BRIEF DESCRIPTION OF THE SEVERAL VIEWS OF THE DRAWINGS

The present invention will be understood better from studying the detailed description of an embodiment, which is given by way of entirely non-limiting example and is illustrated in the appended drawings, in which:

FIG. 1 is a perspective view of a bearing system according to an exemplary embodiment of the invention;

FIG. 2 is a front view of the bearing system in FIG. 1;

FIG. 3 is a half-sectional view along the line III-III in FIG. 2;

FIG. 4 is a half-sectional view along the line IV-IV in FIG. 2;

FIG. 5 is a perspective view of a grounding brush assembly of the bearing system in FIG. 1, shown from one axial end;

FIG. 6 is another perspective view of a grounding brush assembly of the bearing system in FIG. 1, shown from an opposing axial end; and

FIG. 7 is a half-sectional view schematically illustrating the mounting of the bearing system in FIG. 1 inside an electric machine casing.

### DETAILED DESCRIPTION OF THE INVENTION

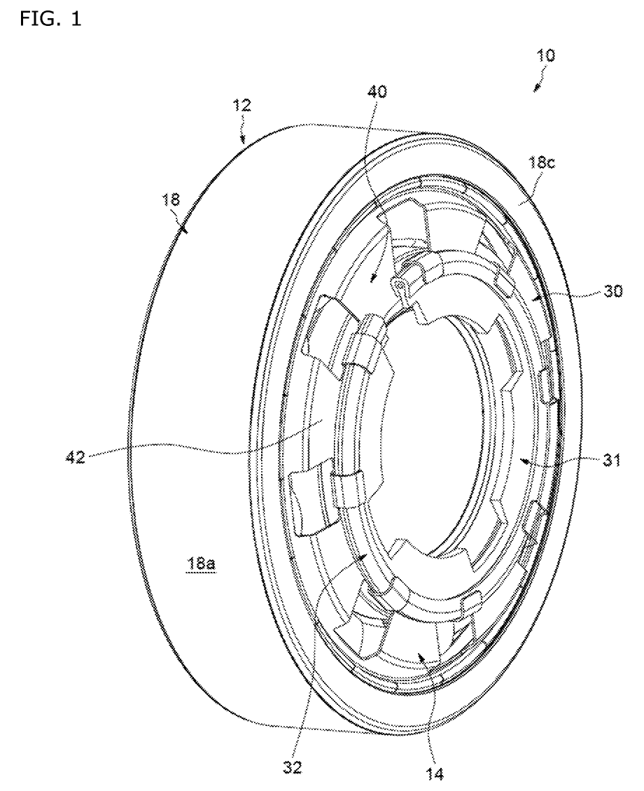

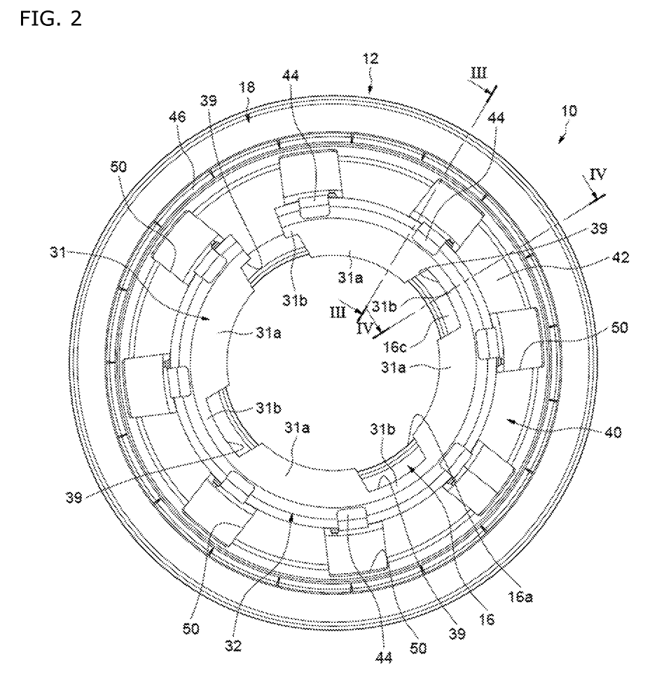

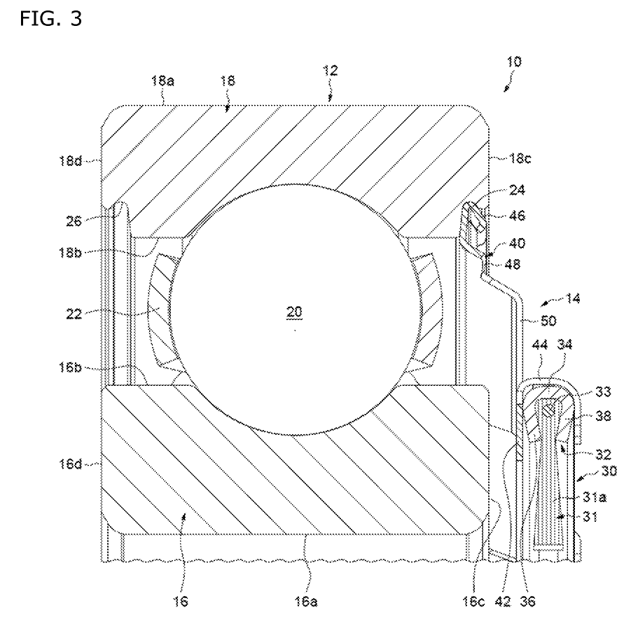

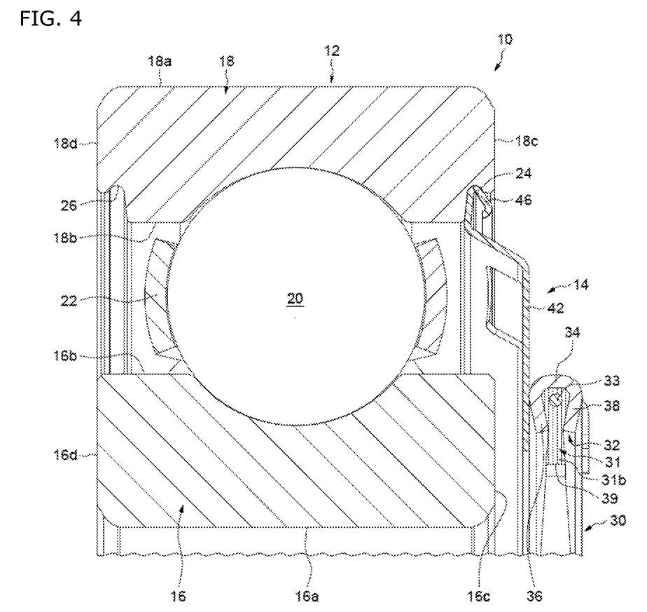

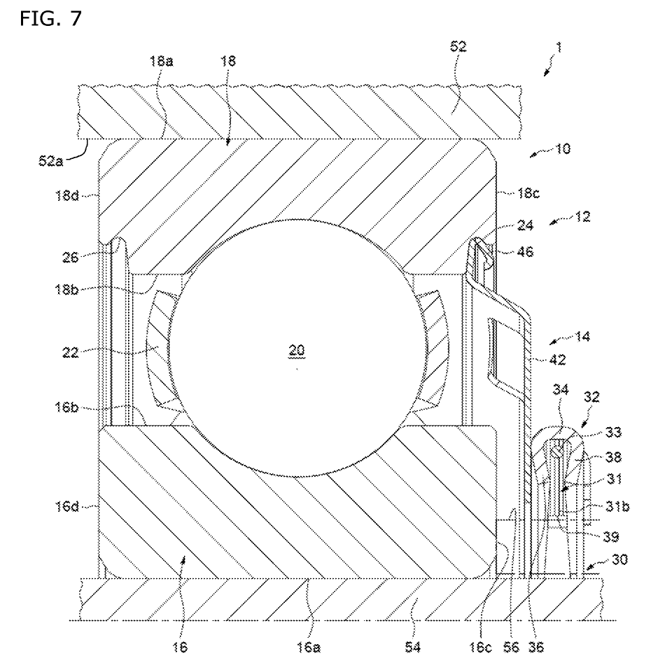

The bearing system 10 illustrated in FIGS. 1 to 4 is intended or designed to be mounted radially between a casing 52 and a rotary shaft 54 of an electric motor or machine 1, as best shown in FIG. 7.

The bearing system 10 comprises a bearing 12 and a grounding brush assembly 14 mounted on the bearing 12.

The bearing 12 is provided with an inner ring 16 and a second outer ring 18 that are able to rotate relative to each other about a central axis (not shown) of the bearing 12. The inner ring 16 and the outer ring 18 of the bearing 12 are concentric and extend axially along the axis of the bearing 12. The inner ring 16 and outer ring 18 are preferably made of steel and are of a solid type.

In the illustrated exemplary embodiment, the bearing 12 also includes a row of rolling elements 20 interposed radially between the inner ring 16 and the outer ring 18 and are preferably formed as balls. However, the rolling elements 20 may be formed as any other appropriate type, such as cylindrical rollers, tapered rollers, needles, etc. The bearing 12 also includes a cage 22 for maintaining the regular circumferential spacing of the rolling elements 20.

The inner ring 16 has a cylindrical bore 16a, a cylindrical axial outer surface 16b radially opposite the bore 16a, and first and second opposite radial end faces 16c, 16d axially delimiting the bore 16a and the outer surface 16b. The bore 16a and the outer surface 16b delimit the radial thickness of the inner ring 16. The end faces 16c, 16d delimit the axial length of the inner ring 16.

The outer ring 18 comprises a cylindrical axial outer surface 18a, a cylindrical bore 18b radially opposite the outer surface 18a, and first and second opposite radial end faces 18c, 18d axially delimiting the bore 18b and the outer surface 18a. The outer surface 18a and the bore 18b delimit the radial thickness of the outer ring 18. The faces 18c, 18d delimit the axial length of the outer ring 18.

The outer ring 18 also comprises first and second annular grooves 24, 26 that are formed in the bore 18b and extend radially outwardly. Each groove 24, 26 is radially oriented towards the inner ring 16; i.e., the grooves 24, 26 face the outer surface 16b of the inner ring 16.

The grooves 24, 26 are disposed axially on either side of the row of rolling elements 20. The groove 24 is situated axially proximal to the end face 18c of the outer ring 18 and the groove 26 is situated axially proximal to the end face 18d. The grooves 24, 26 are mutually symmetrical with respect to the radial midplane of the bearing system 10. Alternatively, the outer ring 18 may have only the one groove 24.

The grounding brush assembly 14 is fixed in the groove 24 in the outer ring 18 of the bearing 12. The assembly 14 has a generally annular shape and includes a grounding brush 30 and a brush mounting plate 40 configured to radially center the brush 30. The mounting plate 40 is fixed in the groove 24 of the outer ring 18 of the bearing 12, specifically by disposing an outer radial end of the plate 40 within the groove 24.

The brush 30 is offset axially outwardly with respect to the inner ring 16 of the bearing 12. In other words, the brush 30 is spaced apart axially from the inner ring 16 of the bearing 12. The brush 30 is disposed outside of the bearing 12.

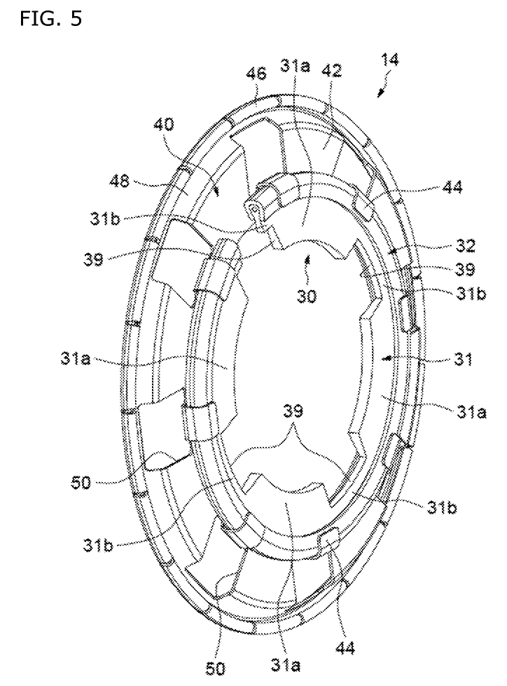

The brush 30 comprises a plurality of individual conductive fibers 31 which are intended to come around the rotary shaft 54 of the motor 1. The conductive fibers 31 may be made of carbon, stainless steel, a conductive plastic, such as fibers made of acrylic or nylon, or any other appropriate electrically conductive material. In FIGS. 1, 2, 5 and 6, the conductive fibers 31 are shown schematically.

The brush 30 further includes a holding or support member 32, inside which the conductive fibers 31 are mounted or disposed. The conductive fibers 31 protrude radially inwardly with respect to the support 32 (i.e., inwardly toward the shaft 54).

As will be described in greater detail below, the conductive fibers 31 include a first group of fibers 31a and a second group of fibers 31b having different radial lengths protruding or extending with respect to the support 32.

In the illustrated exemplary embodiment, the support 32 is preferably formed generally as an open ring and is made of a rigid material. The support 32 may be produced by cutting and pressing/forming in a stamping operation. The support 32 is made from an electrically conductive material such as aluminum, stainless steel, bronze, copper or any other appropriate material. Alternatively, the support 32 may be made from an electrically non-conductive material with a conductive coating or a conductive paint applied to the support 32.

The brush 30 also preferably comprises a ring 33 around which the conductive fibers 31 are arranged inside of the support 32. The ring 33 acts as a support for the conductive fibers 31 and is mounted inside of the support 32.

The support 32 of the brush 30 includes an axial mounting portion 34 and two opposite lateral flanks 36, 38 extending radially inwardly from the mounting portion 34 and axially gripping the conductive fibers 31. The conductive fibers 31 press axially on each side against the lateral flanks 36, 38. The conductive fibers 31 press radially against the mounting portion 34. The conductive fibers 31 protrude radially inwardly with respect to the lateral flanks 36, 38 of the support 32.

The mounting portion 34 and the two lateral flanks 36, 38 delimit a channel (not indicated) which is open radially on the inside and inside of which the conductive fibers 31 are partially positioned or disposed.

The lateral flank 36 extends from one axial end of the mounting portion 34 and the lateral flank 38 extends an opposite axial end of the portion 34. The lateral flanks 36, 38 extend obliquely inwardly from the mounting portion 34. The lateral flanks 36, 38 are symmetrical with each other about a radial midplane of the support 32. Alternatively, just one of the lateral flanks 36, 38 could extend obliquely inwardly. In another variant, both lateral flanks 36, 38 could extend entirely radially. Preferably, the mounting portion 34 extends substantially axially. Alternatively, the mounting portion 34 could extend obliquely.

The brush 30 is preferably formed generally as an open ring. Such an open ring structure allows the brush 30 to adapt to suit different diameters of the motor shaft 54. In general, the brush 30 has two circumferential ends (not indicated) which are not joined or connected together. As a variant, the circumferential ends of the brush 30 may be connected together.

As indicated hereinabove, the conductive fibers 31 comprise a first group of fibers 31a and a second group of fibers 31b of different radial lengths.

The conductive fibers 31a of the first group have distal free ends which are intended to come into radial contact with the outer surface of the rotary shaft 54 of the motor 1. The free ends of the conductive fibers 31a of the first group define the inside diameter of the conductive fibers 31, and more generally the inside diameter of the brush 30.

In the illustrated exemplary embodiment, the free ends of the conductive fibers 31a are offset radially inwardly with respect to the bore 16a of the inner ring 16 of the bearing 12. In other words, the free ends of the conductive fibers 31a protrude radially with respect to the bore 16a of the inner ring 16. Alternatively, the free ends of the conductive fibers 31a could be radially flush with the bore 16a. In another alternative, the free ends of the conductive fibers 31a could be radially spaced apart from, or set back with respect to, the bore 16a in a construction in which the bearing system 10 further comprises a sleeve (not shown) mounted in the bore 16a of the inner ring 16.

The conductive fibers 31b of the second group of fibers 31 have distal free ends which are intended to remain radially at a distance from, or spaced apart from, the outer surface of the rotary shaft 54 of the motor 1. The radial length of the fibers 31b of the second group protruding or extending with respect to the support 32 is less than the radial length of the fibers 31a of the first group protruding/extending with respect to the support 32.

The free ends of the conductive fibers 31b are offset radially outwardly with respect to the bore 16a of the inner ring 16 of the bearing 12. In other words, the free ends of the conductive fibers 31b are radially set back with respect to, or spaced apart from, the bore 16a of the inner ring 16.

Preferably, the free ends of the conductive fibers 31b of the second group are situated at a radial distance from the bore 16a which is between 25% and 50% of the radial thickness of the inner ring 16.

As will be described in greater detail below, the conductive fibers 31b of the second group of reduced radial dimension are provided for mounting the bearing system 10 inside of the associated electric motor 1.

The bore of the conductive fibers 31, and more generally the bore of the brush 30, has a crenellated shape. Each opening 39 or cutout of the crenellated shape is delimited radially by conductive fibers 31b of the second group of fibers 31 and circumferentially by conductive fibers 31a of the first group of fibers 31.

Thus, in the exemplary embodiment illustrated, there exists in the circumferential direction a succession of conductive fibers 31a of the first group and conductive fibers 31b of the second group of fibers 31. The conductive fibers 31a of the first group of fibers 31 are thus arranged in subgroups spaced apart from each other in the circumferential direction, and the conductive fibers 31b of the second group of fibers 31 are arranged in subgroups spaced apart from each other in the circumferential direction, a subgroup of conductive fibers 31b being interposed circumferentially between two successive subgroups of conductive fibers 31a. The conductive fibers 31 form a ring of fibers 31 which continues in the circumferential direction between these two ends.

The circumferential dimension or length of the subgroups of the conductive fibers 31a of the first group of fibers 31 is preferably greater than the circumferential dimension or length of the subgroups of the conductive fibers 31b of the second group of fibers 31.

The openings 39 in the conductive fibers 31 are spaced apart from one another in the circumferential direction, in this instance evenly. Alternatively, the openings 39 may be irregularly circumferentially spaced. Preferably, there are four of the openings 39 in the brush 30. Alternatively, it is possible to provide a greater or smaller number of openings 39. For example, it is possible to provide only a single opening 39.

The mounting plate 40 of the grounding brush assembly comprises an annular radial portion 42 and a plurality of retaining tongues 44 for axially and radially retaining the brush 30 and which extend from the radial portion 42.

The mounting plate 40 also comprises a radially outer fixing portion 46 fixed in the groove 24 of the outer ring 18 of the bearing 12, and a connecting portion 48 connecting the fixing portion 46 to the radial portion 42.

The radial portion 42 of the mounting plate 40 bears axially against the support 32 of the brush 30. More specifically, the radial portion 42 bears axially against the lateral flank 36 of the support 32. The radial portion 42 is offset axially outwardly with respect to the inner ring 16 of the bearing 12. The radial portion 42 remains axially at a distance spaced apart from the end face 16c of the inner ring 16. The support 32 of the brush 30 bears axially against the radial portion 42 axially on the side opposite the inner ring 16. Alternatively, depending on the design of the mounting plate 40, the support 32 of the brush 30 may bear axially against the radial portion 42 axially on the side of the inner ring 16. In this case, the support 32 is disposed axially between the radial portion 42 of the mounting plate 40 and the face 16c of the inner ring 16, remaining axially spaced apart from the inner ring face 16c.

The tongues 44 are spaced apart from each other in the circumferential direction, preferably evenly as depicted. Alternatively, it could be possible to provide an irregular circumferential spacing. In the illustrated exemplary embodiment, there are eight of the tongues 44. Alternatively, it is possible to provide a greater or smaller number of tongues 44; for example, it is possible to provide two tongues 44 or four or more tongues 44. Preferably, the number of tongues 44 is at least equal to two.

Each tongue 44 protrudes axially with respect to the radial portion 42. Each tongue 44 locally radially surrounds the support 32 of the brush 30 and is in radial contact with the mounting portion 34 of the support 32. The support 32 is held axially bearing against the radial portion 42 of the mounting plate 40 by the tongues 44. The tongues 44 serve for axially and radially retaining the grounding brush 30. The lateral flank 36 of the support 32 bears against the radial portion 42 of the mounting plate 40, and the lateral flank 38 bears against the tongues 44. The tongues 44 are preferably formed generally identical to one another.

Each tongue 44 is provided with an axial portion extending axially from the radial portion 42, locally radially surrounding the support 32 and in radial contact therewith, and with a radially inwardly bent-over portion provided at the free end of the axial portion. The bent-over portion of each tongue 44 serves for axially retaining the support 32 of the grounding brush 30. The bent-over portion of each tongue 44 is in axial contact against the lateral flank 38 of the support 32.

The fixing portion 46 of the mounting plate 40 is force-fitted into the groove 24 of the outer ring 18 of the bearing 12. In the illustrated exemplary embodiment, the fixing portion 46 is made in the form of sectors folded back on themselves to match the shape of the groove 24. The sectors are spaced apart from one another in the circumferential direction. Alternatively, the fixing portion 46 could be annular. The fixing portion 46 defines the outside diameter of the mounting plate 40.

The fixing portion 46 is offset radially outwards with respect to the tongues 44 and offset axially towards the interior of the bearing 12 with respect to the tongues 44.

The connecting portion 48 of the mounting plate 40 is annular and has a stepped shape. The connecting portion 48 extends between the edge of large diameter of the radial portion 42 and the edge of small diameter of the fixing portion 46.

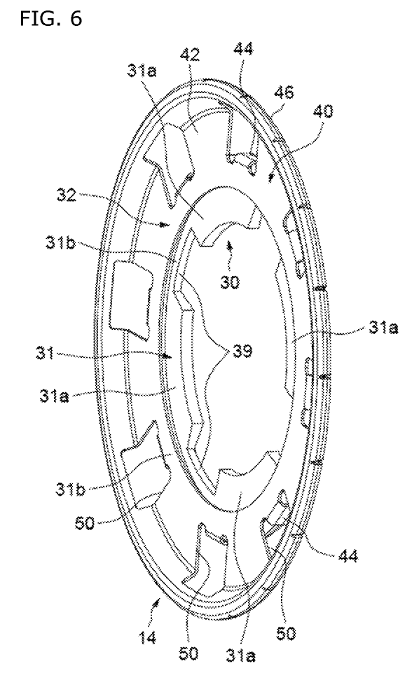

A plurality of through-openings 50 is formed in the thickness of the radial portion 42 and of the connecting portion 48 of the mounting plate 40. The openings 50 are formed during the partial cutting of the mounting plate 40 to form the tongues 44. The tongues 44 are formed by cutting, bending and crimping the mounting plate 40. The openings 50 are spaced apart from one another in the circumferential direction. Each tongue 44 is aligned in the circumferential direction with the associated opening 50. The number of openings 50 corresponds to the number of tongues 44. As can be seen in FIG. 6, the root of each tongue 44 extends from an inner edge of the associated opening 50 which is situated on the radial portion 42.

The mounting plate 40 is produced by cutting and forming (i.e., in a stamping operation). The mounting plate 40 is made from a conductive material such as aluminum, stainless steel, bronze, copper or another appropriate material. Alternatively, the mounting plate 40 may be made from an electrically non-conductive material with a conductive coating or a conductive paint applied to the plate 40. In this instance, the mounting plate 40 is made as a single piece.

As indicated hereinabove, the conductive fibers 31b of the second group of reduced radial dimension are provided for mounting the bearing system 10 inside the associated electric motor.

As illustrated in FIG. 7, to mount the brush system 10 inside the bore 52a of the casing 52 of the associated electric motor 1 and on the rotary shaft 54 of the motor 1, a mounting tool 56 is used, partially shown by dotted lines in FIG. 7.

The tool 56 is brought to bear axially against the end face 16c of the inner ring of the bearing in order to be able to push the bearing system 10 axially until it comes to bear against a stop surface of the casing 52 of the associated electric motor 1, which is provided for the purpose of axially retaining or locating the bearing system 10.

The tool 56 is insertable so as to extend axially through the cutouts 39 in the conductive fibers 31 of the brush, remaining at a distance from the fibers 31. Preferably, the tool 56 has a plurality of fingers each extending axially through a separate one of the cutouts 39 of the conductive fibers 31. The fingers of the tool 56 are disposable radially between the shaft 54 of the electric motor and the free ends of the second group of fibers 31b and come to bear axially against the inner ring 16 of the bearing 12. The fingers of the tool 56 each have a radial dimension smaller than the radial distance between the bore 16a of the inner ring 16 of the bearing 12 and the free ends of the second group of fibers 31b of the brush 30. Also, the fingers of the tool 56 each have a circumferential dimension smaller than the circumferential dimension of the cutouts 39 of the conductive fibers 31 of the brush 30.

While the electric motor 1 is in operation, any electric charge that builds up on the shaft 54 is dissipated to the casing 52 through the conductive fibers 31, the support 32 of the brush 30, and the mounting plate 40 of the assembly 10.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A bearing system comprising:
a bearing including an inner ring and an outer ring, at least one of the inner and outer rings being rotatable relative to the other one of the inner and outer rings; and
a grounding brush assembly fixed to the outer ring of the bearing and including a brush offset axially outwardly with respect to the inner ring of the bearing, the brush having a support and a plurality of conductive fibers disposed at least partially within the support so as to protrude radially inwardly with respect to the support;
wherein the conductive fibers of the brush of the grounding brush assembly include at least a first group of fibers, the free ends of the first group of fibers defining an inside diameter of the brush, and a second group of fibers each having a radial length reduced relative to a radial length of each one of the first group of fibers, the free end of each one of the second group of fibers being offset radially outwardly with respect to the bore of the inner ring of the bearing.

2. The system according to claim 1, wherein the free ends of the first group of fibers of the conductive fibers are offset radially inwardly with respect to the bore of the inner ring of the bearing or are flush with the bore of the inner ring.

3. The system according to claim 1, wherein the bore of the brush of the grounding brush assembly has a crenellated shape, each opening of the crenellated shape being delimited radially by conductive fibers of the second group of fibers and circumferentially by conductive fibers of the first group of fibers.

4. The system according to claim 1, wherein the grounding brush assembly is fixed directly to the outer ring of the bearing without interposition of an intermediate element.

5. The system according to claim 1, wherein the grounding brush assembly is fixed within a groove formed in the bore of the outer ring of the bearing.

6. The system according to claim 1, wherein the grounding brush assembly further includes a brush mounting plate integral with the brush support and fixed to the outer ring of the bearing.

7. A kit comprising:
a bearing system according to claim 1; and
a mounting tool including at least one finger having a radial dimension less than a radial distance between the bore of the inner ring of the bearing and the free ends of the second group of fibers of the conductive fibers of the brush of the grounding brush assembly.

8. An electric motor comprising:
a casing;
a shaft; and
at least one bearing system according to claim 1 mounted radially between the casing and the shaft, the first group of fibers of the conductive fibers of the brush of the grounding brush assembly being in contact with the shaft.

9. A method for mounting a bearing system according to claim 1 between a casing and a shaft of an electric motor, the method comprising the steps of:
providing a mounting tool;
inserting the mounting tool radially between the shaft and the free ends of the second group of fibers of the conductive fibers of the brush of the grounding brush assembly and axially bearing against the inner ring of the bearing; and
pushing the bearing system along the shaft using the mounting tool.
